(19) United States
(12) Patent Application Publication
(10) Pub. No.: US 2026/0084490 A1
(43) Pub. Date: Mar. 26, 2026

(54) USEFUL LIFE ESTIMATING APPARATUS FOR VEHICLE COMPONENT

(71) Applicant: TOYOTA JIDOSHA KABUSHIKI KAISHA, Toyota-shi Aichi-ken (JP)

(72) Inventor: Junichi MIYATA, Toyota-shi Aichi-ken (JP)

(73) Assignee: TOYOTA JIDOSHA KABUSHIKI KAISHA, Toyota-shi Aichi-ken (JP)

(21) Appl. No.: 19/336,783

(22) Filed: Sep. 23, 2025

(30) Foreign Application Priority Data
Sep. 24, 2024 (JP) 2024-165061

(51) Int. Cl. B60H 1/00; G05B 23/02

(52) U.S. Cl. CPC B60H 1/00978; G05B 23/0283

(57) ABSTRACT

A useful life estimating apparatus for a vehicle component that prevents the component from reaching the end of useful life before the end of an expected useful life thereof. The controller includes: a history memory for storing a load on the predetermined component; a comparer for comparing an actual fatigue of the component stored in the history memory with a reference fatigue; and a determiner for determining that the component will reach the end of the useful life before the end of a reference useful life, when the comparer determines that the actual fatigue is greater than the reference fatigue.

### CROSS-REFERENCE TO RELATED APPLICATIONS

The present disclosure claims the benefit of Japanese Patent Application No. 2024-165061 filed on Sep. 24, 2024 with the Japanese Patent Office, the entire contents of which are hereby incorporated by reference.

### BACKGROUND

### Technical Field

The embodiment of the present disclosure relates to the art of an apparatus for estimating a useful life of a component arranged in a vehicle.

### Discussion of the Related Art

JP-A-2014-020804 describes a remaining life determining system for stationary storage battery that estimates a remaining life of a stationary storage battery obtained by recycling a battery used in a vehicle. According to the teachings of JP-A-2014-020804, a plurality of maps for estimating the remaining life of the stationary storage battery in different usage environment where a temperature and an installation location are different are stored in the remaining life determining system. Specifically, in order to estimate the remaining life of the stationary storage battery, the remaining life determining system calculates an actual discharge capacity and an internal resistance from a voltage value, a current value etc. of the stationary storage battery. Then, a map corresponding to the usage environment of the stationary storage battery is selected, and the remaining life of the stationary storage battery is estimated with reference to the selected map based on the calculated actual discharge capacity and the internal resistance. The estimated remaining life is displayed on the display unit, and when the user desires to improve the remaining life, some modules constituting the stationary storage battery are replaced by the operator.

As described above, the remaining life determining system described in JP-A-2014-020804 estimates the remaining life of the storage battery with reference to the map corresponding to the usage environment of the stationary storage battery. That is, according to the teachings of JP-A-2014-020804, the remaining life of the storage battery is determined on the assumption that the storage battery is used in predetermined conditions. However, a load acting on the components mounted on a vehicle varies depending on the way of driving the vehicle by the user and the environment in which the vehicle is operated. Therefore, it is difficult to prepare a map or the like for determining the remaining life of a component taking account of the operating manner and the usage environment of the vehicle at the design phase. For example, when a vehicle is operated in a manner or an environment by which a component is subjected to a high load, the high load acts on the component continuously from the time of determining the remaining life of the component, and an accumulation of fatigue damage of the component will increase. In such circumstances, the component may reach the end of the useful life before the end of an expected useful life thereof under the predetermined condition described in JP-A-2014-020804. That is, the life of the component may reach the end of the useful life within a guarantee period.

### SUMMARY

The embodiment of the present disclosure has been conceived noting the foregoing technical problems, and it is therefore an object of the present disclosure to provide a useful life estimating apparatus for a vehicle component that prevents the component from reaching the end of useful life before the end of an expected useful life thereof.

According to the exemplary embodiment of the present disclosure, there is provided a useful life estimating apparatus that estimates a useful life of a predetermined component arranged in a vehicle. In order to determine a useful life of the predetermined component, a controller of the useful life estimating apparatus includes: a history memory that is configured to store a load acting on the predetermined component; a comparer that is configured to compare an actual fatigue of the predetermined component calculated based on the load stored in the history memory with a reference fatigue calculated based on a predetermined load expected to act on the predetermined component; and a determiner that is configured to determine that the predetermined component will reach the end of the useful life before the end of a reference useful life, when the comparer determines that the actual fatigue is greater than the reference fatigue.

In a non-limiting embodiment, the controller may be further configured to estimate the load acting on the predetermined component based on a temperature of the predetermined component.

In a non-limiting embodiment, the predetermined component may include an electronic component to which an electric current is supplied in accordance with a required driving force to propel the vehicle. In addition, the controller may be further configured to estimate the load acting on the predetermined component based on the required driving force to propel the vehicle.

In a non-limiting embodiment, the useful life estimating apparatus may further comprise a cooling device that cools the predetermined component by feeding a coolant to the predetermined component. In addition, the controller may be further configured to estimate the load acting on the predetermined component based on a temperature of the coolant.

In a non-limiting embodiment, the useful life estimating apparatus may further comprise a life extender that is configured to reduce the load acting on the predetermined component less than a predetermined load, when the determiner determines that the predetermined component will reach the end of the useful life before the end of the reference useful life.

In a non-limiting embodiment, the useful life estimating apparatus may further comprise a cooling device that cools the predetermined component by feeding a coolant to the predetermined component, and he cooling device may include a radiator that radiates a heat of the coolant. In addition, the controller may further comprise a life extender that is configured to increase an amount of heat radiation through the radiator than a predetermined amount or increase a flow rate of the coolant than a predetermined rate, when the determiner determines that an estimated useful life of the predetermined component is shorter than the reference useful life.

Thus, the useful life estimating apparatus according to present disclosure is configured to compare the reference fatigue calculated based on the predetermined load expected to act on the component and the actual fatigue calculated based on the actual load acting on the component which is stored in the history memory. If the actual fatigue is greater than the reference fatigue, the useful life estimating apparatus according to present disclosure estimates that the component will reach the end of the useful life before the end of the expected useful life. According to present disclosure, therefore, it is possible to determine that the component will reach the end of the useful life before the end of the expected useful life based on a manner of operating the vehicle by the driver and the usage environment of the vehicle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing a vehicle to which the useful life estimating apparatus according to the exemplary embodiment of the present disclosure is applied;

FIG. 2 is a block diagram showing functions of the useful life estimating apparatus according to the embodiment of the present disclosure;

FIG. 3A is a histogram showing an example of data about a change in a temperature of the element processed by a learner;

FIG. 3B is a histogram showing an example of data about a change rate of a position of an accelerator pedal processed by the learner;

FIG. 3C is a histogram showing an example of data about a change in a temperature of cooling water processed by the learner;

FIG. 4A is a comparison chart comparing the data about the change in the temperature of the element processed by the learner and the reference data;

FIG. 4B is a comparison chart comparing the data about the change rate of a position of the accelerator pedal processed by the learner and the reference data;

FIG. 4C is a comparison chart comparing the data about the change in the temperature the cooling water processed by the learner and the reference data; and

FIG. 5 is a flow chart showing an example of a routine executed by a controller according to the embodiment of the present disclosure.

### DETAILED DESCRIPTION OF THE EMBODIMENT(S)

An exemplary embodiment of the present disclosure will now be explained with reference to the accompanying drawings. It should be noted that the embodiment described below is merely an example of the present disclosure which should not limit a scope of the present disclosure.

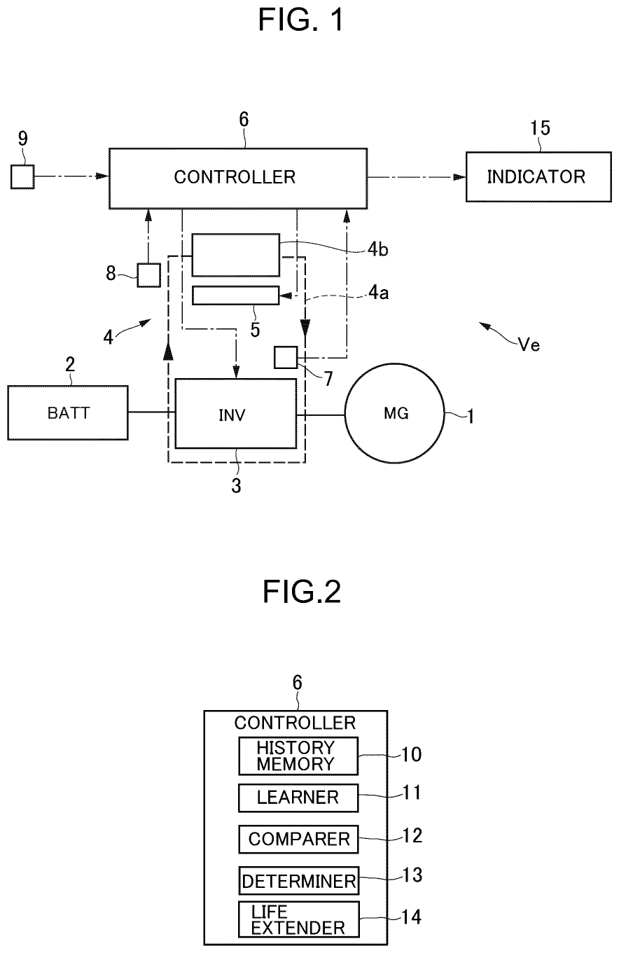

Turning now to FIG. 1, there is schematically shown one example of a vehicle Ve to which the useful life estimation apparatus according to the exemplary embodiment of present disclosure is applied. As illustrated in FIG. 1, the vehicle Ve comprises a motor (referred to as MG in FIG. 1) 1 serving as a prime mover. For example, an AC motor such as a synchronous motor or an induction motor arranged in conventional electric vehicles or hybrid vehicles to serve as a prime mover may be adopted as the motor 1. The motor 1 serves as a motor by supplying electric power thereto to generate a drive torque, and serves as a generator by rotating an output shaft thereof passively to translate at least a part of power rotating the output shaft into electric power.

The vehicle Ve is provided with an electric storage device (referred to as BATT in FIG. 1) 2 serving as a power source of the motor 1, and the electric storage device 2 may be charged with the electric power generated by the motor 1. For example, a secondary battery such as a nickel-hydrogen battery or a lithium-ion battery may be adopted as the electric storage device 2. That is, the electric storage device 2 is a DC power supply. Instead, a battery pack in which a plurality of batteries are connected in series may also be adopted as the electric storage device 2. Further, the electric storage device 2 may include an electric double layer condenser (or capacitor).

The DC electricity outputted from the electric storage device 2 is converted into AC electricity by an inverter (referred to as INV in FIG. 1) 3 to be supplied to the motor 1, and the AC electricity generated by the motor 1 is converted into DC electricity by the inverter 3 to be supplied to the electric storage device 2. As the inverters arranged in the conventional vehicles, the inverter 3 includes electronic components (not shown) such as a plurality of transistors and diodes. Transistors include insulated-gate bipolar transistors (abbreviated as IGBT), metal-oxide-semiconductor field-effect transistors (abbreviated as MOSFET) and the like.

The inverter 3 generates heat in accordance with a current value supplied thereto. Therefore, the inverter 3 is cooled by a cooling device 4 to limit the damage of the inverter 3 resulting from a temperature rise. As indicated by the broken line in FIG. 1, the cooling device 4 is provided with a flow path 4a formed around a case holding the inverter 3 so that the heat of the inverter 3 is conducted to cooling water (i.e., coolant) flowing through the flow path 4a via the case.

The cooling device 4 further comprises a radiator 4b. As the conventional radiators arranged in vehicles having an engine serving as a prime mover, the radiator 4b is arranged on the flow path 4a in the front section of the vehicle Ve. Therefore, the heat of the cooling water may be dissipated to the air passing through the radiator 4b during propulsion. As an option, the cooling device 4 may be provided with a pump (not shown) for controlling the flow rate of the cooling water.

In the vehicle Ve, a radiator fan 5 that is rotated by a motor (not shown) is arranged in the rear of the radiator 4b. Therefore, an amount of air flowing through the radiator 4b may be increased by increasing a rotational speed of the radiator fan 5. In other words, a radiation amount through the radiator 4b may be increased.

In order to control the inverter 3 and the radiator fan 5, the vehicle Ve is provided with an electronic control unit (hereinafter referred to as the “controller”) 6. The controller 6 includes a microcomputer configured to transmit a command signal to e.g. the inverter 3 and the radiator fan 5 based on incident signals, using arithmetic expressions and with reference to maps stored therein.

In the example shown in FIG. 1, signals are transmitted to the controller 6 from an element temperature sensor 7 that detects temperatures of the electronic components of the inverter 3, a water temperature sensor 8 that detects a temperature of the cooling water, and an accelerator sensor 9 that detects a position of an accelerator pedal (not shown). Specifically, the water temperature sensor 8 is positioned downstream of the flow path 4a so as to detect the temperature of the cooling water immediately before flowing back to the radiator 4b. Thus, the sensors 7, 8, and 9 detect the numerical values of parameters affecting the durability of the inverter 3.

The controller 6 is further configured to estimate remaining useful lives of the electronic components of the inverter 3. FIG. 2 is a block diagram for explaining functions to estimate the remaining useful lives of the electronic components. As shown in FIG. 2, the controller 6 comprises a history memory 10, a learner 11, a comparer 12, a determiner 13, and a life extender 14. In the following description, the inverter 3 and the electronic components included therein will be simply referred to as an inverter 3. In the exemplary embodiment of the present disclosure, the inverter 3 including the electronic components serves as a “predetermined component”.

The signals representing a numerical value of each parameter detected by the sensors 7, 8, and 9 are transmitted to the history memory 10 and stored therein. That is, the history memory 10 stores data relating a load acting on the inverter 3.

In a situation where the current supplied to the inverter 3 is increased or decreased repeatedly, the inverter 3 is heated and cooled repeatedly. As a result, materials of the inverter 3 having different linear expansion coefficients are subjected to a load derived from a difference of thermal stress therebetween, and the inverter 3 is damaged. That is, the load acting on the inverter 3 may be estimated by detecting a temperature of the inverter 3 by the element temperature sensor 7. Therefore, a temperature of the inverter 3 detected by the element temperature sensor 7 is stored as the load acting on the inverter 3 in the history memory 10.

A required driving force for propelling the vehicle Ve varies with a change in the position of the accelerator pedal, and consequently the current supplied to the motor 1 (that is, the current flowing through the inverter 3) is changed. That is, the load acting on the inverter 3 may also be estimated by detecting a position of the accelerator pedal by the accelerator sensor 9. Therefore, the position of the accelerator pedal detected by the accelerator sensor 9 is stored as the load acting on the inverter 3 in the history memory 10.

A temperature of the cooling water is increased by a temperature rise of the inverter 3. That is, the load acting on the inverter 3 may also be estimated by detecting a temperature of the cooling water. Therefore, the temperature of the cooling water detected by the water temperature sensor 8 is stored as the load acting on the inverter 3 in the history memory 10.

Thus, the history memory 10 is configured to store the data relating to the load acting on the inverter 3. To this end, for example, an ammeter may be arranged on the output side of the inverter 3. In this case, the current value detected by the ammeter may be stored as the load acting on the inverter 3 in the history memory 10.

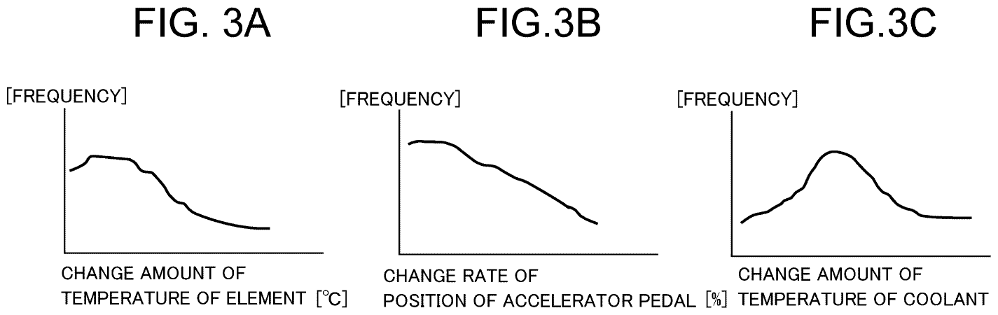

The learner 11 is configured to learn an actual fatigue of the inverter 3 based on the data stored in the history memory 10. Specifically, the learner 11 creates data for preparing the histogram shown in FIGS. 3A to 3B based on the data stored in the history memory 10. For example, the limit of fatigue accumulated in the inverter 3 may be evaluated based on the number of times to increase and decrease the electric power supplied to the inverter 3 within a predetermined period of time in a power cycle test.

FIG. 3A shows an example of a histogram in which the horizontal axis represents an amount of change in a temperature of the element as a bin and the vertical axis represents the number of times that the temperature of the element has changed in each bin as a frequency, FIG. 3B shows an example of a histogram in which the horizontal axis represents a change rate of a position of the accelerator pedal as a bin and the vertical axis represents the number of times that the position of the accelerator pedal has changed in each bin as a frequency, and FIG. 3C shows an example of a histogram in which the horizontal axis represents an amount of change in a temperature of the cooling water as a bin and the vertical axis represents the number of times that the temperature of the cooling water has changed in each bin as a frequency.

Specifically, the amount of change in the temperature of the element is a difference between the lowest temperature and the highest temperature of the element within a predetermined period of time, the change rate of the position of the accelerator pedal is a value obtained by dividing a difference between the shallowest position and the deepest position of the accelerator pedal within a predetermined period of time by the predetermined period of time, and an amount of change in the temperature of the cooling water is a difference between the lowest temperature and the highest temperature of the cooling water within a predetermined period of time.

Thereafter, in order to learn the actual fatigue of the inverter 3, the learner 11 multiplies the frequency by a predetermined coefficient determined for each of the bins, and learns the calculated value as the actual fatigue of the inverter 3.

The comparer 12 compares the actual fatigue of the inverter 3 learned by the learner 11 with a reference fatigue calculated based on an assumption that the vehicle Ve is operated in a normal manner expected at the design phase, or that the vehicle Ve is operated in a normal environment expected at the design phase. For this purpose, a load distribution that determines a fatigue limit of the inverter 3 prepared based on a result of the power cycle test conducted at the design phase is stored in the comparer 12. The comparer 12 creates data for preparing a reference histogram on the basis of the above-mentioned load distribution, a reference useful life of the inverter 3 calculated at the design phase, and an actual duration of use of the inverter 3 at the present moment.

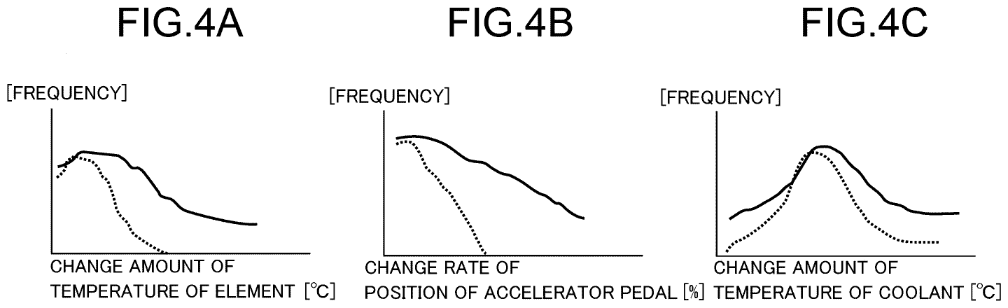

Then, the comparer 12 compares the histogram created by the learner 11 based on the data stored in the history memory 10 indicated by the solid curve in FIGS. 4A to 4C with the reference histogram created based on the data created by the comparer 12 indicated by the broken curve in FIGS. 4A to 4C. In the example shown in FIGS. 4A to 4C, the data values in all bins stored in the history memory 10 are greater than the data values created by the comparer 12.

Nonetheless, the data values in all bins stored in the history memory 10 are not always greater than the data values created by the comparer 12. In such case, the actual fatigue and the reference fatigue may be compared by multiplying a difference in frequency in each bin by a predetermined coefficient set for each bin, and accumulating the calculated values. That is, the comparer 12 may be configured to calculate the difference between the actual fatigue and the reference fatigue by quantifying the difference.

The determiner 13 determines whether or not the inverter 3 will reach the end of the useful life before the end of the reference useful life as a guarantee period thereof, based on a result of the comparison between the actual fatigue and the reference fatigue conducted by the comparer 12. Specifically, in a case that the actual fatigue is greater than the reference fatigue, the determiner 13 predicts that the inverter 3 will reach the end of useful life before the end of the reference life. In this case, since the fatigue has been accumulated in the inverter 3 more than expected up to the present moment, the determiner 13 predicts that the driving operation by which the inverter 3 is subjected to a large load will continue, or the traveling environment (or condition) where the load acting on the inverter 3 is large will continue. Therefore, the determiner 13 determines that the inverter 3 will reach the end of the useful life before the end of the reference useful life, when the actual fatigue is greater than the reference fatigue.

The determiner 13 may be further configured to quantify the remaining useful life of the inverter 3. To this end, specifically, the determiner 13 quantifies the remaining useful life of the inverter 3 by calculating an acceptable fatigue by subtracting an actual fatigue from a fatigue by which the inverter 3 reaches the end of the reference useful life, and dividing the calculated acceptable fatigue by the actual fatigue while multiplying by the current duration of use. Thereafter, the determiner 13 determines whether or not an estimated useful life calculated by adding the duration of use to the quantified remaining useful life is shorter than the reference useful life.

In a case that the determiner 13 determines that the inverter 3 will reach the end of the useful life before the end of the reference useful life, the life extender 14 executes a life extending control to reduce the load acting on the inverter 3. In this case, for example, the life extender 14 reduces the load acting on the inverter 3 by reducing a required driving torque for the motor 1 with respect to a position of the accelerator pedal. Otherwise, the life extender 14 reduces the load acting on the inverter 3 by reducing the amount of change in the torque of the motor 1 with respect to the operation amount of the accelerator pedal.

Instead, in order to reduce the load acting on the inverter 3, the life extender 14 increases a rotational speed of the radiator fan 5 thereby increasing an amount of heat radiation through the radiator 4b than an amount of heat dissipation of a case in which the inverter 3 is not expected to reach the end of the useful life before the end of the reference useful life.

Otherwise, in order to reduce the load on the inverter 3, the life extender 14 increases a discharge amount of the pump of the cooling device 4 thereby increasing a flow rate of the cooling water than a flow rate of a case in which the inverter 3 is not expected to reach the end of the useful life before the end of the reference useful life.

For example, the amount of reduction in the required driving torque for the motor 1, the amount of reduction in the torque of the motor 1 with respect to the operation amount of the accelerator pedal, the amount of increase in the rotational speed of the radiator fan 5, and the amount of increase in the discharge amount of the pump of the cooling device 4 may be determined in accordance with the difference between the estimated useful life and the reference useful life.

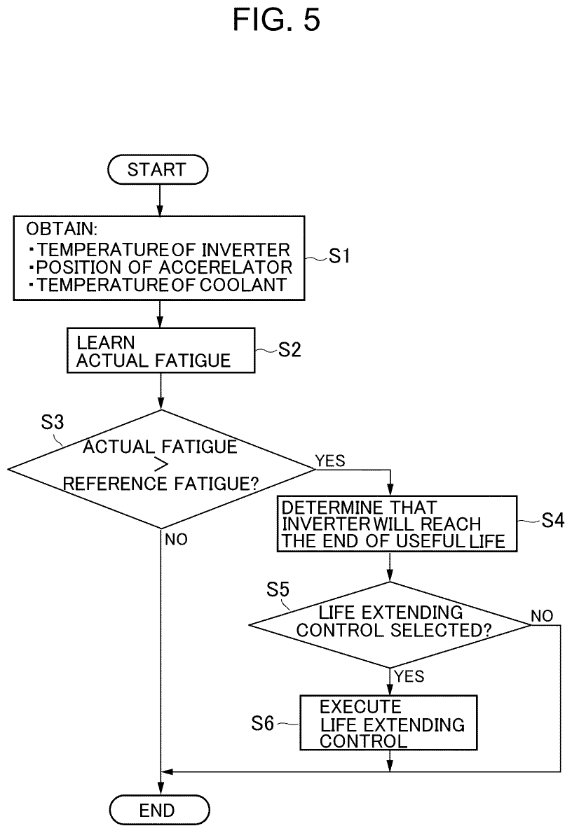

FIG. 5 is a flowchart for explaining an example of the control executed by the controller 6. At step S1, the controller 6 reads the temperature of the inverter 3, the position of the accelerator pedal, and the temperature of the cooling water from the history memory 10.

At step S2, the learner 11 learns the actual fatigue of the inverter 3. Specifically, the learner 11 creates data for preparing the histogram shown in FIGS. 3A to 3C based on the data stored in the history memory 10, and learns the actual fatigue of the inverter 3 based on the created data.

At step S3, the comparer 12 determines whether the actual fatigue is greater than the reference fatigue. In a case that the actual fatigue is less than the reference fatigue so that the answer of S3 is NO, this means that the load acting on the inverter 3 is small. That is, the vehicle Ve is operated in such a manner that the load acting on the inverter 3 is small, or the vehicle Ve is operated in a condition where the load acting on the inverter 3 is small. In this case, the inverter 3 will not reach the end of its useful life before the end of the reference useful life, even if the vehicle Ve is operated continuously by the current manner or in the current condition. Therefore, if the answer of step S3 is NO, the routine returns.

By contrast, in a case that the actual fatigue is greater than the reference fatigue so that the answer of step S3 is YES, this means that the load acting on the inverter 3 is greater than the expected load estimated at the design phase. That is, the vehicle Ve is operated in such a manner that the load acting on the inverter 3 is large, or the vehicle Ve is operated in the condition where the load acting on the inverter 3 is large. In this case, therefore, the routine progresses to step S4, and at step S4, the determiner 13 determines that the inverter 3 will reach the end of the useful life before the end of the reference life.

At step S5, for example, a message to confirm the user whether or not to execute the life extending control is indicated in an indicator 15 such as an instrument panel. In addition, at step S5, it is determined whether or not the user has selected to execute the life extending control. For these purposes, the controller 6 transmits a signal to the indicator 15 to indicate e.g., the message to confirm the user whether or not to execute the life extending control.

If the user does not select to execute the life extending control so that the answer of step S5 is NO, the routine returns. By contrast, if the user selects to execute the life extending control so that the answer of step S5 is YES, the routine progresses to step S6 to execute the life extending control. Thereafter, the routine returns.

As described above, the life extending control of the inverter 3 is executed by the life extender 14. Specifically, in order to reduce the load acting on the inverter 3, the life extender 14 reduces a required driving torque for the motor 1 with respect to a position of the accelerator pedal, or reduces an amount of change in the torque of the motor 1 with respect to an operation amount of the accelerator pedal. Otherwise, the life extender 14 increases a rotational speed of the radiator fan 5 or a discharge amount of the pump of the cooling device 4.

Thus, the comparer 12 compares the reference fatigue calculated based on the load estimated at the design phase to act on the inverter 3 with the actual fatigue calculated based on the actual load on the inverter 3 stored in the history memory 10. When the actual fatigue is greater than the reference fatigue, the determiner 13 estimates that the inverter 3 will reach the end of the useful life before the end of the reference life. Therefore, it is possible to determine that the inverter 3 will reach the end of the useful life before the reference useful life based on the driver's driving operation, the traveling environment of the vehicle Ve, and the like.

Further, when the vehicle Ve is operated in such a manner that the vehicle Ve is subjected to a load higher than that estimated at the design phase, or when the vehicle Ve is operated in an environment where the vehicle Ve is subjected to a load higher than that expected at the design phase such as in a mountainous area, the determiner 13 determines that the inverter 3 will reach the end of the useful life before the end of the reference life. In this case, the life extender 14 executes the life extending control to reduce the load acting on the inverter 3. Therefore, it is possible to prevent the inverter 3 from reaching the end of the useful life before the end of the reference life.

Given that the life extending control is executed, a change in the driving torque of the motor 1 is reduced, and consequently the acceleration response may be reduced. In addition, as a result of increasing the rotational speed of the radiator fan 5, a power consumption and noises may be increased. Nonetheless, since the life extending control is executed selectively in line with the intention of the user, the user will not be frustrated even if the behavior of the vehicle Ve changes as explained above.

Further, since the life extending control is available, the vehicle Ve may not be designed to withstand high loads. That is, it is not necessary to increase the durability of the inverter 3. For this reason, it is not necessary to employ a large inverter or an expensive inverter.

In addition, the useful life estimating apparatus according to the embodiment of the present disclosure may also estimate remaining useful lives of components other than the inverter that are fatigued by the traveling load. For example, the useful life estimating apparatus according to the embodiment of the present disclosure may also estimate the remaining useful life of a mechanical component that transmits torque to drive wheels from the prime mover. Further, the useful life estimating apparatus according to the embodiment of the present disclosure may also be applied to a vehicle in which only an engine is employed as a prime mover, instead of an electric vehicle having a motor.

What is claimed is:

1. A useful life estimating apparatus that estimates a useful life of a predetermined component arranged in a vehicle, comprising:
a controller that determines the useful life of the predetermined component,
wherein the controller comprises
a history memory that is configured to store a load acting on the predetermined component,
a comparer that is configured to compare an actual fatigue of the predetermined component calculated based on the load stored in the history memory with a reference fatigue calculated based on a predetermined load expected to act on the predetermined component, and
a determiner that is configured to determine that the predetermined component will reach an end of the useful life before an end of a reference useful life, when the comparer determines that the actual fatigue is greater than the reference fatigue.

2. The useful life estimating apparatus as claimed in claim 1, wherein the controller is further configured to estimate the load acting on the predetermined component based on a temperature of the predetermined component.

3. The useful life estimating apparatus as claimed in claim 1,
wherein the predetermined component includes an electronic component to which an electric current is supplied in accordance with a required driving force to propel the vehicle, and
the controller is further configured to estimate the load acting on the predetermined component based on the required driving force to propel the vehicle.

4. The useful life estimating apparatus as claimed in claim 1, further comprising:
a cooling device that cools the predetermined component by feeding a coolant to the predetermined component,
wherein the controller is further configured to estimate the load acting on the predetermined component based on a temperature of the coolant.

5. The useful life estimating apparatus as claimed in claim 1, wherein the controller further comprises:
a life extender that is configured to reduce the load acting on the predetermined component less than a predetermined load, when the determiner determines that the predetermined component will reach the end of the useful life before the end of the reference useful life.

6. The useful life estimating apparatus as claimed in claim 1, further comprising:
a cooling device that cools the predetermined component by feeding a coolant to the predetermined component,
wherein the cooling device includes a radiator that radiates a heat of the coolant, and
the controller further comprises a life extender that is configured to increase an amount of heat radiation through the radiator than a predetermined amount or increase a flow rate of the coolant than a predetermined rate, when the determiner determines that an estimated useful life of the predetermined component is shorter than the reference useful life.
